(19) United States
(12) Patent Application Publication
(10) Pub. No.: US 2015/0225171 A1
(43) Pub. Date: Aug. 13, 2015

(54) BEVERAGE CUP COMPACTOR

(71) Applicant: Chandra Mohan Reddy Yengoti, Saratoga, CA (US)

(72) Inventor: Chandra Mohan Reddy Yengoti, Saratoga, CA (US)

(21) Appl. No.: 14/176,154

(22) Filed: Feb. 10, 2014

(51) Int. Cl. B65F 1/14; B65F 1/00

(52) U.S. Cl. CPC B65F 1/1463; B65F 1/1607; B65F 1/0006

(57) ABSTRACT

A beverage cup compactor includes a garbage bin lid that has a central hole and a plurality of additional holes. A plurality of pipes are placed in the plurality of holes. Each pipe has an extended top sized so that the extended top rests on a top of the garbage bin lid.

### FIELD OF THE INVENTION

The present invention relates to a beverage cup compactor for discarding used beverage cups.

### BACKGROUND

In current days, “To Go” Cups are widely used for serving beverages and ice cream etc and form a major part of the trash collected in malls, coffee shops and in general at the public garbage bins. The main issue with these discarded cups is that they take up too much space which requires frequent cleaning to avoid overflowing of trash onto the ground. This requires more manual effort and time. Garbage crushers can be used to reduce the volume but they are expensive and cannot be deployed everywhere.

United States Patent Application No. 20110192293 to Hitchcock; Jim et. al entitled ‘Trash Compactor’ deals with compacting trash at predetermined intervals. It also provides a signal for the removal of the trash either manually or automatically when the trash receptacle is full.

### BRIEF DESCRIPTION OF THE DRAWINGS

FIG. 1 shows a garbage bin lid containing additional holes with pipes in accordance with an embodiment.

FIG. 2 shows a pipe made of metal or plastic with top end expanded to hold itself onto the garbage bin lid in accordance with an embodiment.

FIG. 3 and FIG. 4 show a pipe with an opening in the side wall for dropping the cups in accordance with an embodiment.

FIG. 5 shows a garbage bin with a base to hold and stack the beverage cups in accordance with an embodiment.

FIG. 6 and FIG. 7 show a garbage bin with a space created in the form of pipe to stack the beverage cups in accordance with an embodiment.

FIG. 8, FIG. 9 and FIG. 10 show an open garbage bin with pipe containing a hinge in accordance with an embodiment.

### REFERENCE NUMERALS

Garbage bin lid 1
Central hole 2
Additional holes 3
Pipe 4
Expanded top opening 5
Side wall opening 6
Base 7
Hinge 8
Semi-circular space 9
Garbage bin 10
Garbage bin 11
Bin lid 12
Pipe 18
Pipe 19
Garbage bin 20
Garbage bin 33
Garbage bin Lid 31
Central hole 32
Beverage compactor 35
Garbage bin 40

### DETAILED DESCRIPTION

A simple and cost effective beverage cup compactor is used for discarding beverage cups in a stacked manner to reduce the space taken up in garbage bins.

According to a first embodiment, the beverage cups are compacted using a garbage bin lid that can be retrofitted into the existing garbage bins. The garbage bin lid contains additional holes to hold pipes made of metal or plastic which is used to stack used beverage cups to reduce the space they take up in the garbage bins.

The garbage bin lid contains a number of holes drilled in addition to the central hole meant for all trash. The diameter of the holes is larger than the diameter of the largest cup that is generally used. The bin lid includes pipes made of metal or plastic with top end expanded to hold itself onto the garbage bin lid and the pipes are opened at both ends.

A second embodiment is an outdoor garbage bin lid with a sealed top as a protection from the elements. In this case, the opening of the pipe will be cut into the side of the wall and placed into the top sealed garbage bin. The cups are dropped into the pipe through the opening on the sides and not from the top.

According to a third embodiment, the beverage cup compactor is a garbage bin especially used in coffee shops. The garbage bin contains a multiple stacking units with a single common base to hold and stack the used beverage cups. A liner placed inside the bin will help to clear the garbage as soon as it is full.

According to a fourth embodiment, spaces are created in the form of a semi-circular pipe on the outer edge of the garbage bin lid. The spaces are made circular by joining the lid with the inner surface of the open garbage bin to stack the beverage cups without having a pipe. A fifth embodiment is a beverage compactor for open garbage bins used in large venues. Multiple pipes provided with hinges can be attached to the open garbage bin on a need basis to collect beverage cups.

The beverage cup compactor reduces the cost and manual cleaning efforts. It compacts the beverage cups up to 5 to 8 times with a simple modification to the existing garbage bins.

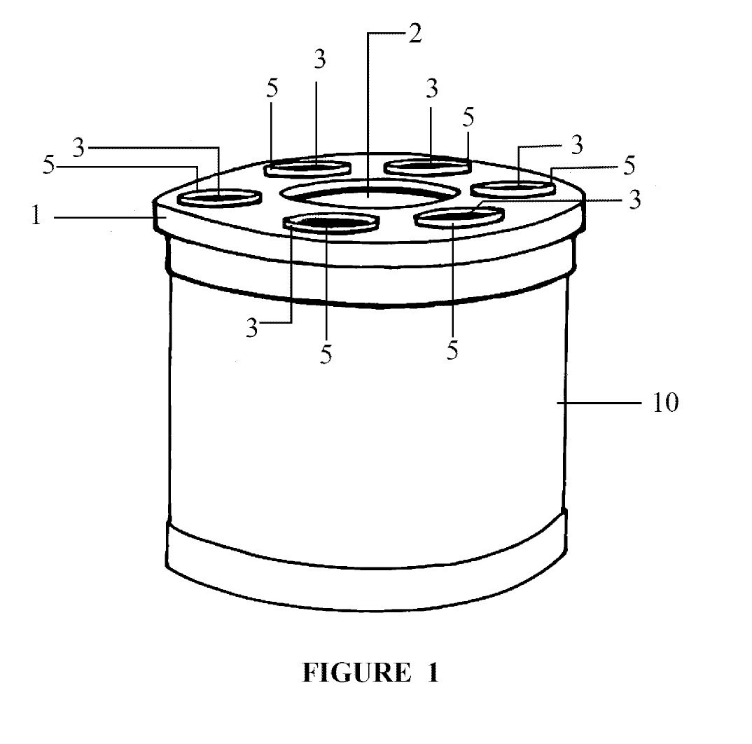

Specifically, FIG. 1 shows a garbage bin lid 1 manufactured with additional holes 3 drilled or otherwise formed in the lid 1 in addition to a central hole 2 meant for all trash. The diameter of the holes 3 can vary depending on the size of the cups used and in general the largest cup size is chosen as the reference for determining the diameter. The diameter of the hole in the pipe is slightly larger than the diameter of the largest beverage cup used so that they can fall through the bottom of the pipe 4 into the liner placed in the garbage bin 10.

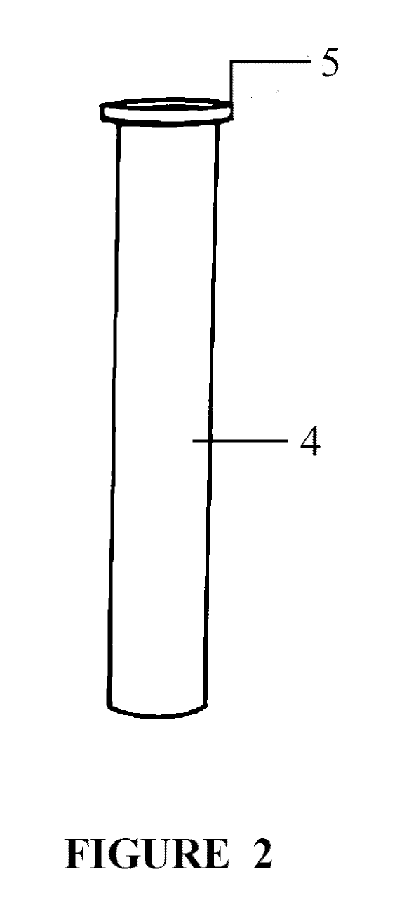

FIG. 2 illustrates a pipe 4 made of metal or plastic with top end expanded 5 to hold itself onto the garbage bin lid 1. The pipe 4 helps the cups that are to be trashed to pile up one over the other as if they are stacked over each other. The pipe 4 is opened at both ends and the opening at the lower end helps to drain the left over fluids in the cups that spill over into the trash liner. The users are to be advised to remove the lids of the discarded cups and trash it separately. The length of the pipe 4 is in such a way that it clears the bottom of the garbage bin 10 (shown in FIG. 1) by an inch or two. When all the tubes 4 are full with the used beverage cups, the top lid 1 of the garbage bin 10 is lifted up and the pipes 4 are lifted along with the lid 1 allowing all the stacked cups to fall into the garbage liner. The garbage is removed and a fresh liner is placed in the garbage bin 10 and the lid 1 is replaced onto the garbage bin 10.

In one embodiment, a bottom opening of the pipe 4 that opens into the garbage bin 10 can be closed partially to hold cups but allows the spilled over liquids to pass through into the liner. This way, the pipe 4 alone can be taken off from the lid 1 and the stacked cups are cleared from the garbage bin 10 from time to time without clearing the entire trash from the bin 10.

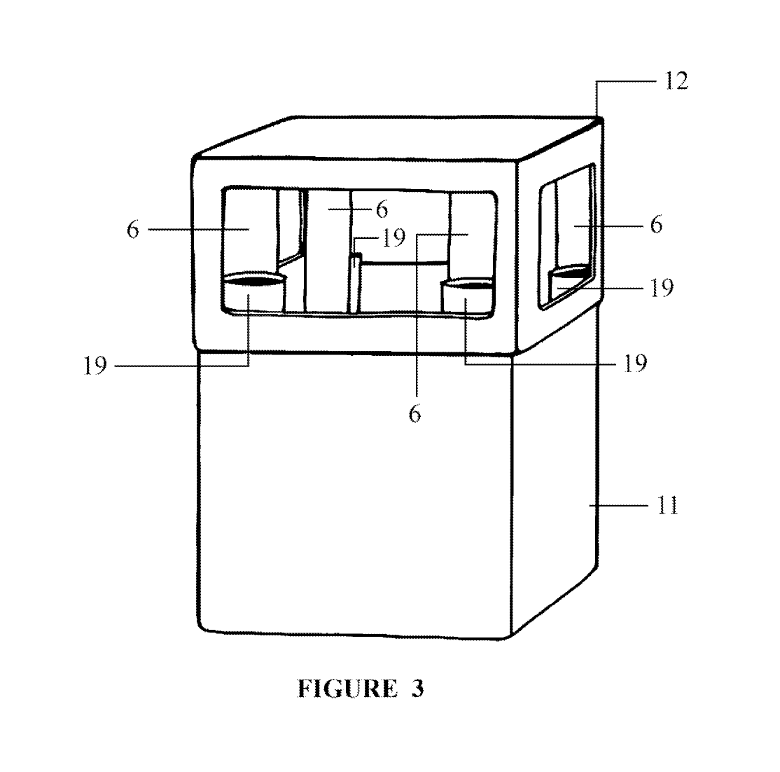

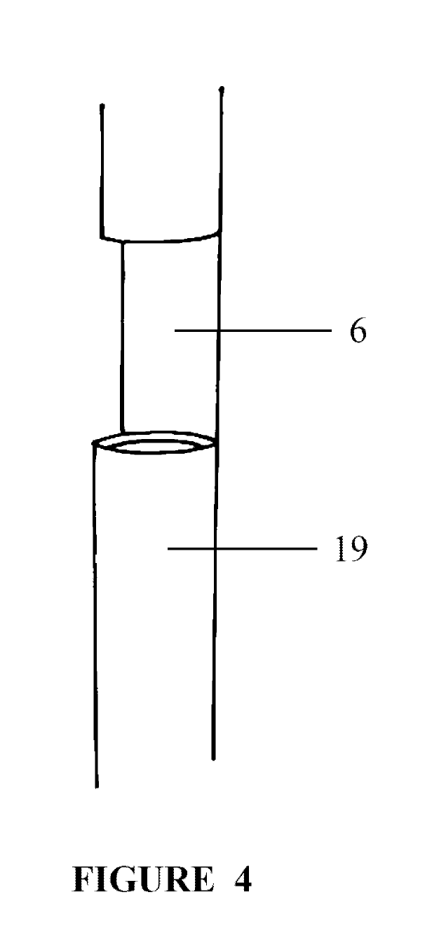

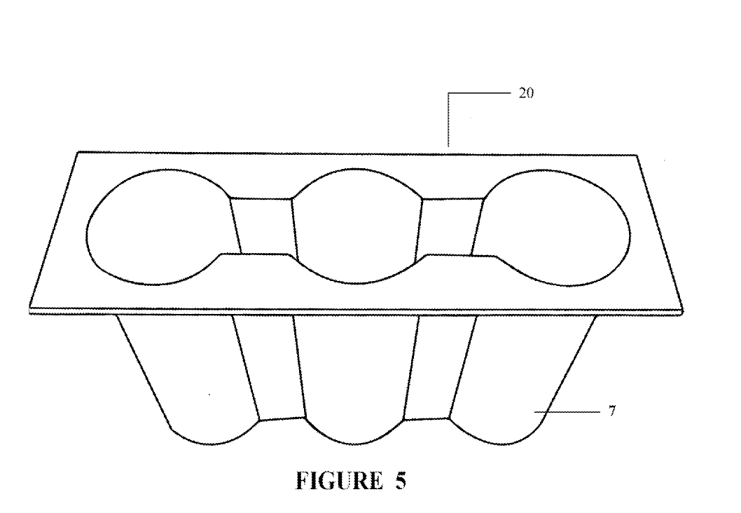

FIG. 3 and FIG. 4 show an outdoor garbage bin 11 with a bin lid 12 that has a sealed top as a protection from the elements. In this case, the opening of each of pipes 19 will be cut into the side of a pipe wall 6 and placed into the top sealed garbage bin lid 12. The cups are dropped into the pipe 19 from the opening on the sides and not from the top.

FIG. 5 shows a garbage bin 20 optimized for coffee shops. The garbage bin 20 contains a plurality of stacking units with a single common base 7 to hold and stack the beverage cups more efficiently. Also, it does not require a pipe because of the in-built pipe-like stacking units. A liner placed inside the bin 20 will help to clear the garbage as soon as it is full. Thus, it avoids frequent cleaning by eliminating the overflowing of trash onto the ground in a short period.

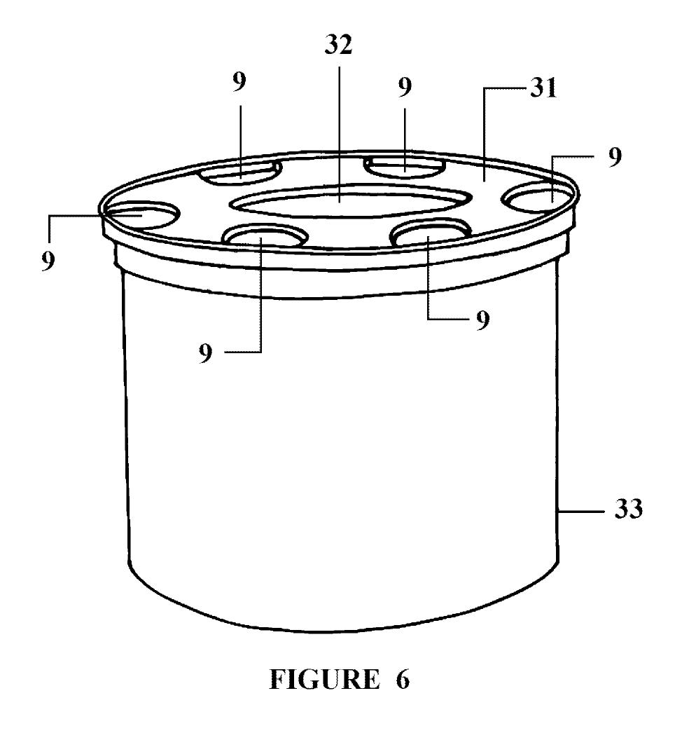

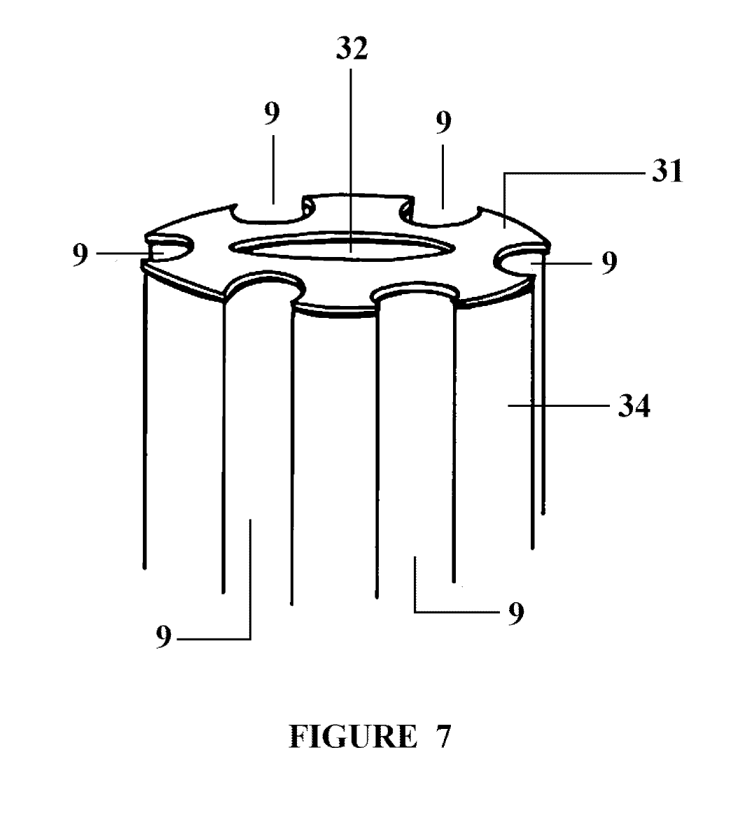

FIG. 6 and FIG. 7 show a beverage cup compactor where spaces are created in the form of a semi-circular pipe on the outer edge of a garbage bin lid 31 on a garbage bin 33. Spaces 9 formed within an insert 34 attached to lid 31 are made approximately circular by joining lid 31 with the inner surface of the open garbage bin 33. This allows for stacking beverage cups without having a pipe. In this way the beverage cups can be stacked in the spaces 9 created and are optimally placed away from a central hole 32 so that more space is available for the unsorted trash in the middle.

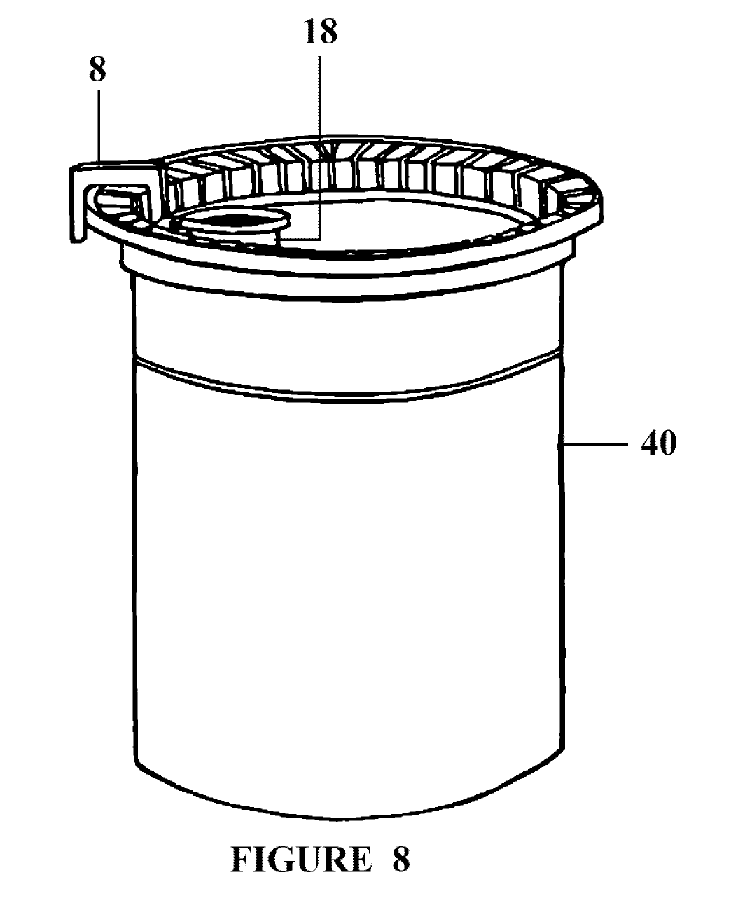

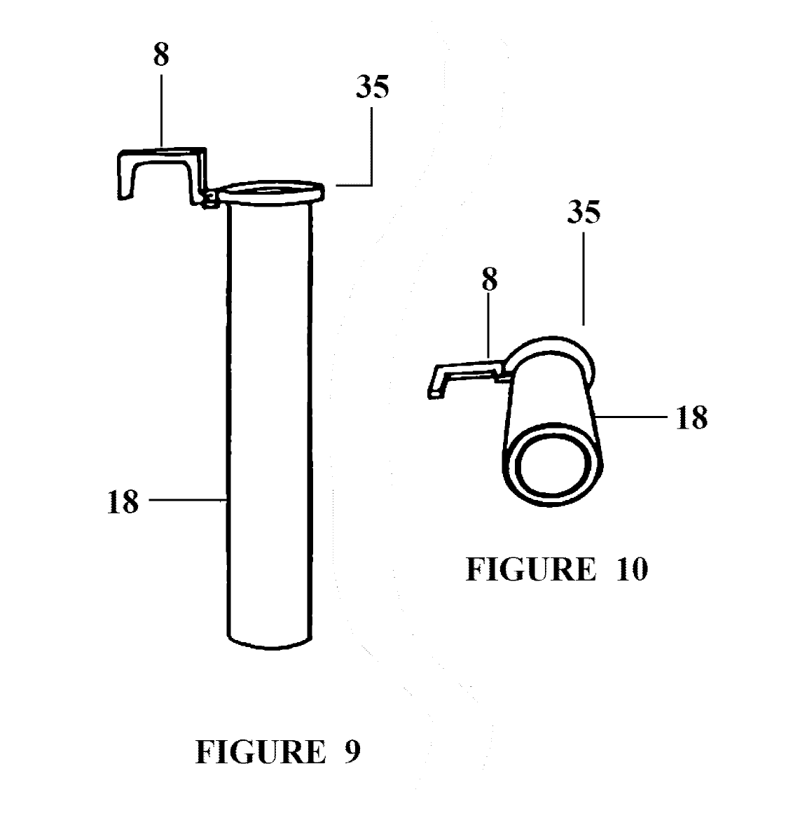

FIG. 8, FIG. 9 and FIG. 10 show a beverage compactor 35 for an open garbage bin 40 placed in the large venues for collecting trash. Beverage compactor 35 includes a pipe 18 and a hinge 8 for attaching with the open garbage bin 40. Multiple pipes provided with hinges can be placed on a need basis to collect beverage cups. Pipes can be selectively cleared of the beverage cup trash into the garbage bin 40 thus collecting more trash to clear at a time.

The beverage cup compactor reduces the cost, manual cleaning efforts and it compacts the beverage cups up to 5 to 8 times with a simple modification to the existing garbage bins.

What is claimed is:

1. A beverage cup compactor, comprising:
a garbage bin lid that includes a central hole and a plurality of additional holes, each additional hole in the plurality of holes having a first diameter size selected to be larger than a second diameter size of cups to be compacted,
a plurality of pipes, each pipe in the plurality of pipes having a third diameter size that is smaller than the first diameter size and larger than the second diameter size, and each pipe in the plurality of pipes having an extended top having a fourth diameter size that is larger than the first diameter size, the plurality of pipes being placed into the plurality of holes so that the extended top for each of the plurality of pipes rests on a top of the garbage lid.

2. The beverage cup compactor according to claim 1, wherein each pipe in the plurality of pipes has an expanded top opening used for reception of, the cups.

3. The beverage cup compactor according to claim 1, wherein each pipe in the plurality of pipes has a sidewall opening used for reception of the cups.

4. The beverage cup compactor according to claim 3, wherein the garbage bin lid includes a sealed top as a protection from elements.

5. The beverage cup compactor according to claim 1, wherein each pipe in the plurality of pipes is opened at a lower end to allow drainage of left over fluids from the cups.

6. The beverage cup compactor according to claim 1, wherein each pipe in the plurality of pipes is fixed to the garbage bin lid.

7. The beverage cup compactor according to claim 6, wherein each pipe in the plurality of pipes is opened at a lower end sufficient to allow drainage of left over fluids from the cups.

8. The beverage cup compactor according to claim 6, wherein each pipe in the plurality of pipes is removably attached to the garbage bin lid.

9. The beverage cup compactor according to claim 8, wherein each pipe in the plurality of pipes is closed partially at the lower end sufficient to prevent the cups from falling out of the pipes.

10. The beverage cup compactor according to claim 1, wherein each pipe in the plurality of pipes has a length less than a length of a garbage bin on which the garbage bin lid is placed.

11. A beverage cup compactor comprising:
a plurality of stacking units with a single base, the stacking units holding and stacking discarded beverage cups; and
a trash liner placed inside a garbage bin, the plurality of stacking units being placed within the trash liner.

12. A beverage cup compactor comprising:
a garbage bin lid, including an insert for placement within a garbage bin, the garbage bin lid having a plurality of indentations on an outer edge, the indentations being shaped in semi-circular form so that when the garbage bin lid is placed within the garbage bin, each indentation in the plurality of indentations combine with an inner surface of the garbage bin to form an approximately circular space in which discarded beverage cups may be stacked.

13. A beverage cup compactor comprising:
a pipe with a diameter sized to receive and stack discarded beverage cups; and a hinge attached to the pipe, the hinge and the pipe being sized to hang the pipe inside an open garbage bin so that the pipe is positioned above a bottom of the garbage bin.

14. A beverage cup compactor according to claim 13, wherein additional pipes with attached hinges are placed within the open garbage bin.
